(19) United States
(12) Patent Application Publication
(10) Pub. No.: US 2010/0188359 A1
(43) Pub. Date: Jul. 29, 2010

(54) TOUCHPAD COMPRISING STRUCTURE FOR TACTILE SENSATION AND TOUCH SENSOR USING THE SAME

(75) Inventor: Bang Won Lee, Yongin-si (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 12/439,718

(22) PCT Filed: Jun. 7, 2007
(86) PCT No.: PCT/KR07/02759

§ 371 Date: Mar. 3, 2009

(30) Foreign Application Priority Data
Sep. 5, 2006 (KR) 10-2006-0084962

(51) Int. Cl. G06F 3/045; G06F 3/041

(52) U.S. Cl. 345/174; 345/173

(57) ABSTRACT

Provided are a touchpad and a touch sensor using the same. The touchpad includes: a printed circuit board (PCB); a plurality of conductors; and a non-conductive board disposed on one surface of the PCB and having a plurality of protrusions respectively including the conductors therein. In addition, the touch sensor includes: the touchpad; and a contact signal generation unit having a plurality of digital contact controllers for sensing delay due to a change in impedance between the conductors in the protrusions and the PCB and outputting a digital signal according to the delay. An apparatus having the touchpad as an input device enables a user to feel the touchpad better.

### TECHNICAL FIELD

The present invention relates to a touchpad, and more particularly, to a touchpad having a structure that can be felt more readily by a user and a touch sensor using the touchpad.

### BACKGROUND ART

Technological development over the years has led to the replacement of many mechanical devices by electronic devices. Nowadays, extensive use of graphic user interfaces (GUIs) has made convenient human interface devices (HIDs) very important. In the recent past, slim, small-sized, lightweight products were frequently pursued, but, lately, users are more interested in convenience and design as well as product functionality. Consequently, methods and devices for providing user convenience are constantly increasing. And, advance design, whereby a product is first designed and then components are matched to the design, is becoming common Recently, an input device using a touchpad based on touch sensing technology has come into the spotlight as a convenient HID.

The touchpad is an input device based on touch sensing technology and is frequently used for providing a convenient interface. Most recently provided Moving Picture Experts Group (MPEG) layer 3 (MP3) players, cellular phones, plasma display panels (PDPs), personal digital assistants (PDAs), etc., have an input unit using a touchpad. The touchpad includes a small flat surface on which a user can input information or instructions to perform an operation by touching the surface with his/her finger or a pen. The touchpad is employed together with a sensor for sensing change of a signal in response to contact of the finger or pen with the flat surface. Application of the touchpad allows more freedom of design. In addition, since a button operation is performed by a simple touch of a finger on the touchpad, the touchpad is more natural to use and requires less effort than a mechanical button. Therefore, touchpads are being used in various products such as monitors, MP3 players, notebook computers, cellular phones, personal digital assistants (PDAs), keyboards, etc., and products using the touchpad are expected to be used in numerous fields.

FIGS. 1 and 2 illustrate a conventional touchpad and its structure. The touchpad has a printed circuit board (PCB) 5, directly on which an insulator structure 1 having a uniform thickness is disposed. In the insulator structure 1, a plurality of conductors 3 are disposed. The conductors 3 are also in contact with the PCB 5. When a human finger 7, which has electrical resistance, touches the conductors 3, resistive components are changed. This change is sensed by a sensor and used to track movement of the finger 7.

As can be seen in FIG. 2, since the touchpad is flat and has no protrusions or bends, a user can hardly feel anything when touching the touchpad and generating an operating signal. This makes the touchpad difficult to use. As an example, when operating an MP3 player, there are many things to examine and consider one by one such as whether a current contact portion is correct for a specific operation, whether a pad portion except a pad portion to be pressed is pressed, how far a user should move his/her finger for a desired operation, and so on. Therefore, it is difficult to operate the touchpad without checking the state of the MP3 player.

As another example, when a contact portion of a touchpad touched by a finger is flat in a mouse for controlling movement of a cursor on a screen, the feeling of a click is not enough for a user. Thus, for operating a touchpad, there are many things to consider such as how hard the touchpad should be pressed to move a screen on a monitor by a desired distance, how far a user should move his finger, and so on.

Notebook computer users often use a mouse rather than a touchpad because of the lack of feeling when using a touchpad.

### DISCLOSURE

### [Technical Problem]

The present invention is directed to a touchpad enabling a user to feel a tactile sensation from its surface.

The present invention is also directed to a touch sensor having the above-mentioned touchpad.

### [Technical Solution]

One aspect of the present invention provides a touchpad comprising: a printed circuit board (PCB); a plurality of conductors; and a non-conductive board disposed on one surface of the PCB and having a plurality of protrusions, each of the plurality of protrusions including each of the plurality of conductors therein.

Another aspect of the present invention provides a touch sensor comprising: a touchpad including a PCB, a plurality of conductors, and a non-conductive board disposed on one surface of the PCB and having a plurality of protrusions, each of the plurality of protrusions including each of the plurality of conductors therein; and a contact signal generation unit comprising a plurality of digital contact controllers for sensing delay due to a change in impedance between each of the plurality of conductors in each of the plurality of protrusions and the PCB to output a digital signal.

The changed impedance may be one of an electrostatic capacitance, an inductive capacitance and a resistance.

Each of the digital contact controllers may comprise: a delay time varying unit for generating a reference signal having a fixed delay time and a sensing signal having a delay time that varies according to an impedance of a signal applied from outside; and a delay time calculating and data generating unit for calculating a difference in delay time between the reference signal and the sensing signal, and generating digital data having a value corresponding to the calculated difference in delay time.

The delay time varying unit may comprise: a measurement signal generator for generating a measurement signal; a fixed delay for delaying the measurement signal for a predetermined time period and generating the reference signal; and a variable delay for changing a delay time according to the impedance value of the signal applied from outside, delaying the measurement signal according to the varied delay time, and generating the sensing signal.

Still another aspect of the present invention provides a touchpad comprising: a PCB; a plurality of PCB electrodes disposed on one surface of the PCB; a non-conductive flat board disposed on the PCB electrodes and covering one entire surface of the PCB except portions at which the PCB electrodes are disposed; and a plurality of conductive buttons put into the uncovered portions of the non-conductive flat board and having respective upper parts protruding above a surface of the non-conductive flat board.

Yet another aspect of the present invention provides a touch sensor comprising a touchpad and a contact signal generation unit. The touchpad comprises: a PCB; a plurality of PCB electrodes disposed on one surface of the PCB; a non-conductive flat board disposed on the PCB electrodes and covering one entire surface of the PCB except portions at which the PCB electrodes are disposed; and a plurality of conductive buttons put into the uncovered portions of the non-conductive flat board and having respective upper parts protruding above a surface of the non-conductive flat board, and the contact signal generation unit comprises: a plurality of digital contact controllers for sensing delay due to a change in impedance between the conductive buttons and the PCB electrodes caused by external contact to output a digital signal.

The changed impedance may be one of an electrostatic capacitance, an inductive capacitance, and a resistance.

Each of the digital contact controllers may comprise: a delay time varying unit for generating a reference signal having a fixed delay time and a sensing signal having a delay time that varies according to an impedance of a signal applied from outside; and a delay time calculating and data generating unit for calculating a difference in delay time between the reference signal and the sensing signal, and generating digital data having a value corresponding to the calculated difference in delay time.

The delay time varying unit may comprise: a measurement signal generator for generating a measurement signal; a fixed delay for delaying the measurement signal for a predetermined time period to generate the reference signal; and a variable delay for varying a delay time according to the impedance value of the signal applied from outside, delaying the measurement signal according to the varied delay time to generate the sensing signal.

Yet another aspect of the present invention provides a touchpad comprising: a PCB; a plurality of PCB electrodes disposed on one surface of the PCB; and a non-conductive board disposed on the PCB electrodes and having a plurality of depressed portions and embossed portions corresponding to the PCB electrodes.

Yet another aspect of the present invention provides a touch sensor comprising a touchpad and a contact signal generation unit. The touchpad comprises: a PCB; a plurality of PCB electrodes disposed on one surface of the PCB; and a non-conductive board disposed on the PCB electrodes and having a plurality of depressed portions and embossed portions corresponding to the PCB electrodes, and the contact signal generation unit comprises: a plurality of digital contact controllers for sensing delay due to a change in impedance between the bottoms of the depressed portions and the PCB electrodes caused by external contact to output a digital signal.

The changed impedance may be one of an electrostatic capacitance, an inductive capacitance and a resistance.

Each of the digital controllers may comprise: a delay time varying unit for generating a reference signal having a fixed delay time and a sensing signal having a delay time that changes according to an impedance of a signal applied from outside; and a delay time calculating and data generating unit for calculating a difference in delay time between the reference signal and the sensing signal, and generating digital data having a value corresponding to the calculated difference in delay time.

The delay time varying unit may comprise: a measurement signal generator for generating a measurement signal; a fixed delay for delaying the measurement signal for a predetermined time period and generating the reference signal; and a variable delay for varying a delay time according to the impedance of the signal applied from outside, delaying the measurement signal according to the varied delay time, and generating the sensing signal.

### [Advantageous Effects]

The touchpad of the present invention can solve the problem of lack of feeling during use resulting in discomfort when using a device employing a conventional touchpad as an input device. This is accomplished by using a structure implemented by forming a plurality of protrusions including conductors therein, a structure implemented by putting a plurality of metal buttons into a plastic structure, and a structure implemented by forming a plurality of depressed portions and embossed portions.

### DESCRIPTION OF DRAWINGS

FIG. 1 illustrates a conventional touchpad;

FIG. 2 is a cross-sectional view showing the internal structure of a conventional touchpad;

FIG. 3 is a plan view of a touchpad according to a first exemplary embodiment of the present invention;

FIG. 4 is a cross-sectional view taken along line X-Y of FIG. 3;

FIG. 5 illustrates a touch sensor using the first exemplary embodiment of the present invention;

FIG. 6 is a plan view of a touchpad according to a second exemplary embodiment of the present invention;

FIG. 7 is a cross-sectional view taken along line X′-Y′ of FIG. 6;

FIG. 8 illustrates a touch sensor using the second exemplary embodiment of the present invention;

FIG. 9 is a plan view of a touchpad according to a third exemplary embodiment of the present invention;

FIG. 10 is a cross-sectional view taken along line a-b of FIG. 9;

FIG. 11 illustrates a touch sensor using the third exemplary embodiment of the present invention;

FIG. 12 illustrates operation of a contact signal generation unit employed in the present invention;

FIG. 13 is a block diagram of a digital contact controller employed in the present invention; and

FIGS. 14 and 15 illustrate exemplary embodiments employing a touchpad of the present invention.

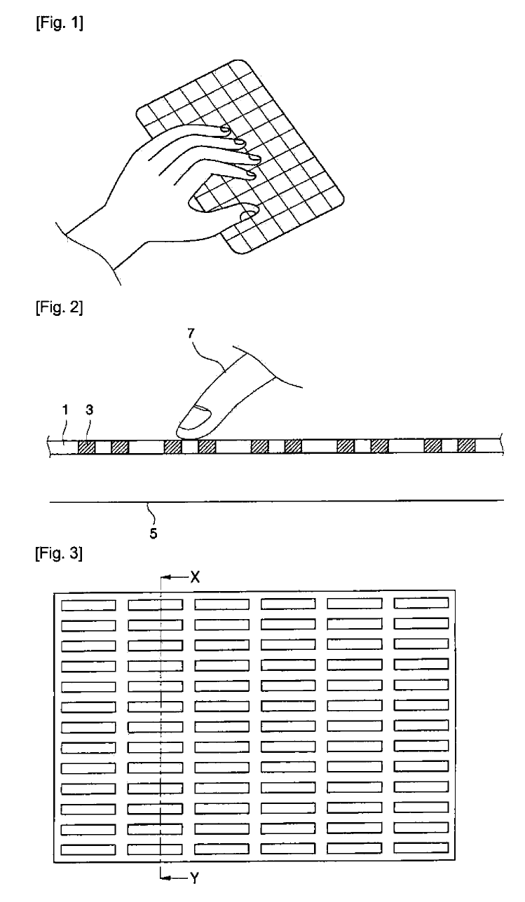

### MODES OF INVENTION

Hereinafter, exemplary embodiments of the present invention will be described in detail. However, the present invention is not limited to the exemplary embodiments disclosed below and can be implemented in various modified forms. The present exemplary embodiments are provided to enable one of ordinary skill in the art to embody and practice the invention.

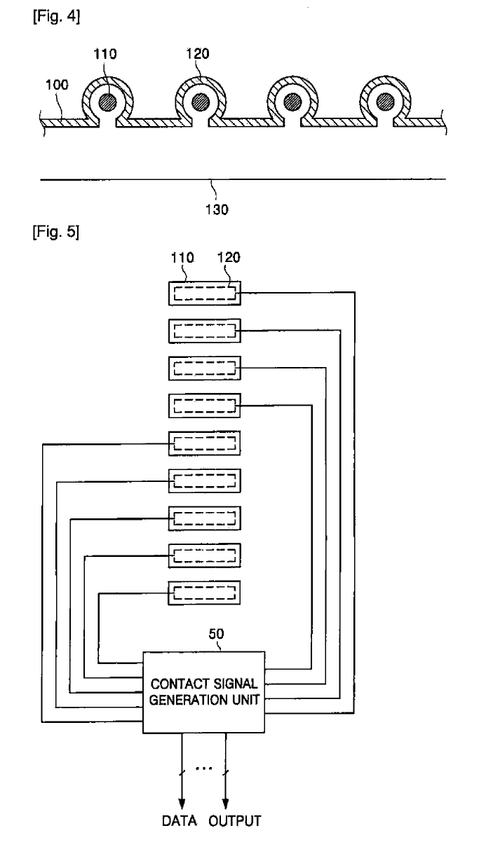

FIG. 3 is a plan view of a touchpad implemented by forming a plurality of protrusions including conductors therein according to a first exemplary embodiment of the present invention. In FIG. 3, a plurality of rectangles denote the protrusions. FIG. 4 is a cross-sectional view taken along line X-Y of FIG. 3.

A printed circuit board (PCB) 130 is disposed in a lower part of the touchpad. A board 100 formed of a non-conductive material such as plastic is disposed on the PCB 130 and constitutes the upper surface of the touchpad which a finger touches. On the non-conductive board 100, a plurality of protrusions 120 are formed to put conductors 110 therein.

FIG. 5 illustrates a part of the touchpad together with a contact signal generation unit for sensing external contact and outputting data according to the first exemplary embodiment of the present invention. Rectangles denote protrusions 120 on a surface of the touchpad, and rectangles indicated by dotted lines denote conductors 110 inside the protrusions 120. The protrusions 120 and conductors 110 enable a user to feel the touchpad better.

When the user touches a protrusion of the touchpad with his finger, an electrostatic capacitance sensed through the conductor 110 inside the touched protrusion varies. The contact signal generation unit 50 has a plurality of digital contact controllers therein sensing varied impedance to output a digital signal according to a contact portion. The variable impedance is one of an electrostatic capacitance, an inductive capacitance and a resistance.

When no contact is made to the touchpad fabricated by forming the protrusions 120 including the conductors 110 therein in the non-conductive board 100, the respective conductors 110 sense a uniform capacitance. When a user presses a protrusion of the touchpad for a desired operation, an electrostatic capacitance sensed by the conductor 110 inside the pressed protrusion varies. The contact signal generation unit 50 having a plurality of digital contact controllers senses a change in the electrostatic capacitance to output a digital signal.

The first exemplary embodiment has a PCB under a non-conductive board on which are formed a plurality of protrusions including conductors therein. Thus, the electrostatic capacitance is formed between the conductors and the PCB. Consequently, the first exemplary embodiment does not need an additional electrode and has an inexpensive and simple structure enabling a user to feel the touchpad better. Meanwhile, bends of the structure are formed to protrude outwardly in FIG. 4, but may alternatively be formed to protrude inwardly. In other words, the non-conductive board may be recessed with conductors inserted in flat portions so that a touch of a finger can be sensed. In addition, the protrusions may be triangular or diamond-shaped. Since the conductors 110 can be separately disposed from the PCB 130, the position of the touchpad may be determined by the product's design without any restrictions.

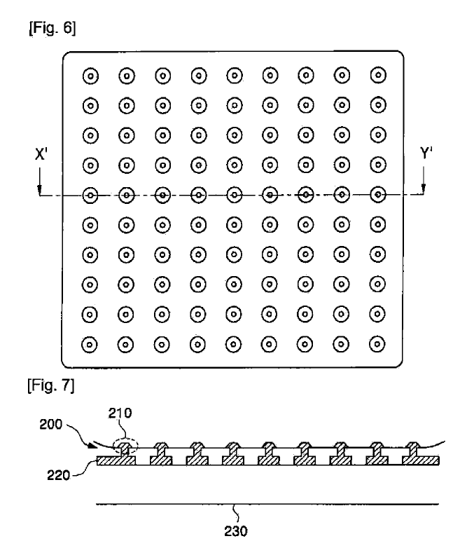

FIG. 6 is a plan view of a touchpad according to a second exemplary embodiment of the present invention. In FIG. 6, a plurality of uniformly arranged circles denote protruding portions to enable a user to feel the touchpad better. FIG. 7 is a cross-sectional view taken along line X′-Y′ of FIG. 6. In order to enable a user to feel the touchpad better when touching it for an operation, the structure of the touchpad has the conductive buttons put into a non-conductive flat board. The touchpad comprises a non-conductive flat board 200, a plurality of conductive buttons 210, a plurality of PCB electrodes 220, and a PCB 230.

The PCB 230 is disposed in the lower part of the touchpad, and the PCB electrodes 220 are disposed in a uniform pattern on the PCB 230. On the PCB 230, the non-conductive flat board 200 into which the conductive buttons 210 can be put is disposed to wrap around the PCB electrodes 220. The conductive buttons 210 are put into the non-conductive flat board 200 to correspond to the PCB electrodes in the uniform pattern.

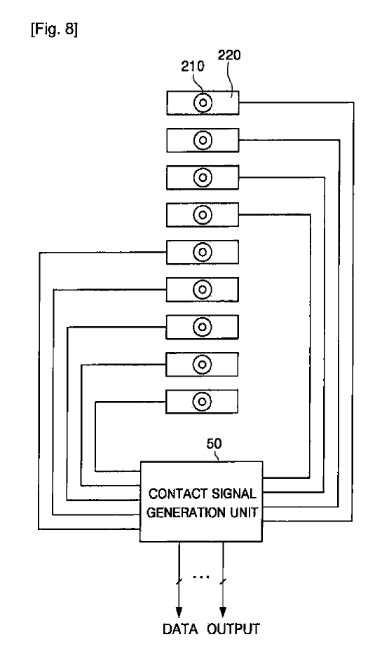

FIG. 8 illustrates a part of the touchpad together with a contact signal generation unit for sensing external contact and outputting a data signal according to the second exemplary embodiment of the present invention. Rectangles denote the PCB electrodes 220 included in the touchpad, and circles denote the conductive buttons 210 put into the non-conductive flat board 200. The conductive buttons 210 enable a user to feel the touchpad better. The respective PCB electrodes 220 are connected with the corresponding digital contact controllers of the contact signal generation unit 50.

When a user touches conductive buttons of the touchpad with his finger, a capacitance formed between the conductive buttons touched by his finger varies. The contact signal generation unit 50 has a plurality of digital contact controllers therein sensing delay caused by varied impedance and outputting a digital signal according to a contact portion. The variable impedance is one of an electrostatic capacitance, inductive capacitance and a resistance.

The digital contact controllers included in the contact signal generation unit 50 sense delay by the electrostatic capacitance, the inductive capacitance or the resistance. Thus, in FIG. 7, the conductive buttons 210 are in contact with the PCB electrodes 220, but they are not necessarily in contact with each other.

Conventional touch sensors use a resistive method and thus have restricted in structures. However, when the contact signal generation unit having digital contact controllers sensing delay by the electrostatic capacitance, the inductive capacitance or the resistance is used, a touch can be easily sensed. This is because although the conductive buttons 210 are disposed apart from the PCB electrodes 220, the bottoms of the conductive buttons 210 are adjacent to the PCB electrodes 220, and thus the electrostatic capacitance increases.

When there is no contact with the conductive buttons 210, a resistance value between the conductive buttons 210 and the PCB electrodes 220 is kept uniform. However, when a user touches the conductive button 210 with his finger, and the conductive button 210 is in contact with the PCB electrodes 220, a resistance value between the conductive button 210 and the PCB electrode 220 is varied by the resistance of the user's finger. Here, the contact signal generation unit 50 senses a change in the resistance value to output digital data.

When a user touches the conductive button 210 with his finger, and the conductive button 210 is not in contact with the PCB electrodes 220, an electrostatic capacitance between the conductive button 210 touched by the user's finger and the PCB electrode 220 is varied. A digital contact controller of the contact signal generation unit 50 senses such a change in the electrostatic capacitance to output digital data.

The structure using the conductive buttons 210 in FIG. 7 may be made to feel high-quality by plating conductive objects with a metal or using stainless objects, and to feel smooth by sloping edges of the conductive buttons.

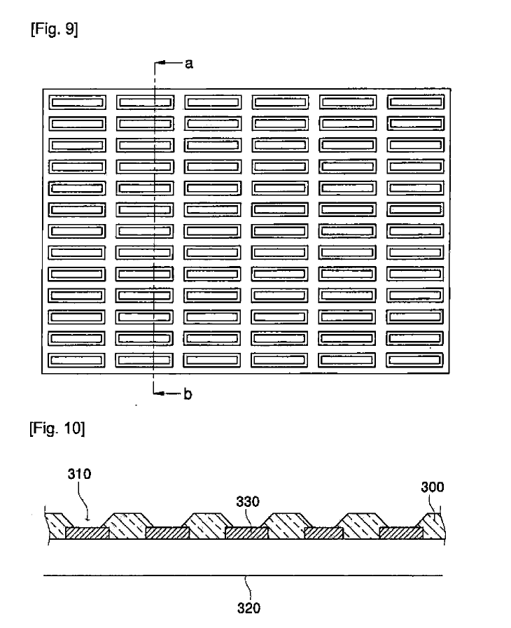

FIG. 9 is a plan view of a touchpad according to a third exemplary embodiment of the present invention. In FIG. 9, a plurality of uniformly arranged rectangles denote protruding portions for a user's sense of touch. FIG. 10 is a cross-sectional view taken along line a-b of FIG. 9. In order to enable a user to feel the touchpad better when touching it for an operation, the structure of the touchpad has a plurality of depressed portions and embossed portions formed by grooving one surface of a non-conductive board.

A PCB 320 is disposed in the lower part of the touchpad, and a plurality of PCB electrodes 330 are disposed at uniform intervals on the PCB 320. On the PCB electrodes 330, a non-conductive flat board 300 in which a plurality of grooves 310 are formed to a depth enabling a user to feel a bend is disposed. The grooves 310 respectively correspond to the PCB electrodes 330.

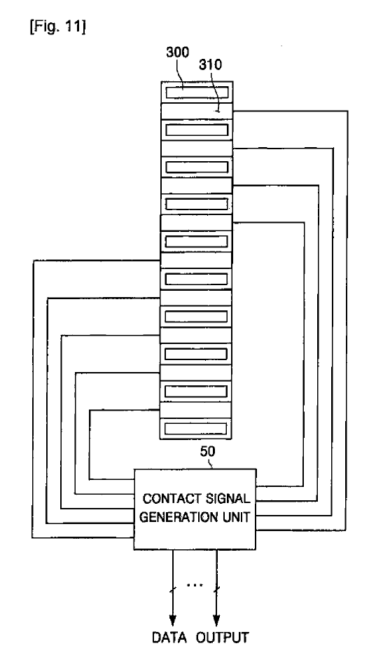

FIG. 11 illustrates a part of the touchpad together with a contact signal generation unit for sensing external contact and outputting a data signal according to the third exemplary embodiment of the present invention. Folded rectangles denote embossed portions formed by grooving the non-conductive board 300 to enable a user to feel the touchpad better, and rectangles denote the lower surfaces of the grooves 310 or the PCB electrodes 330. The respective PCB electrodes 330 are connected with the corresponding digital contact controllers of the contact signal generation unit 50.

When a user touches a groove of the touchpad with his finger, a resistance value between the finger, which has electrical resistance, and a PCB electrode varies. The contact signal generation unit 50 has a plurality of digital contact controllers therein sensing delay caused by varied impedance to output digital data according to a contact portion. The variable impedance is one of an electrostatic capacitance, an inductive capacitance and a resistance.

The digital contact controllers included in the contact signal generation unit 50 sense delay by a capacitance, inductance or resistance value. Thus, in FIG. 10, a user's finger directly touches the PCB electrode 330, but they do not necessarily come in contact with each other.

While there is no contact with the grooves 310, impedance is kept uniform. When a user touches the lower surface of the groove 310 with his finger to perform an operation, and the groove 310 is in contact with the PCB electrodes 330, the finger comes in direct contact with the PCB electrode 330, and a resistance value is changed by the finger. Here, the contact signal generation unit 50 senses a change in the resistance value and outputs digital data.

Even when the user's finger does not come in direct contact with the PCB electrode 330 because a non-conductive cover having a uniform thickness is disposed on the PCB electrodes 330 in contact with the grooves 310, a change in capacitance can be sensed by a high-sensitivity digital contact controller. Here, the digital contact controller of the contact signal generation unit 50 to output digital data.

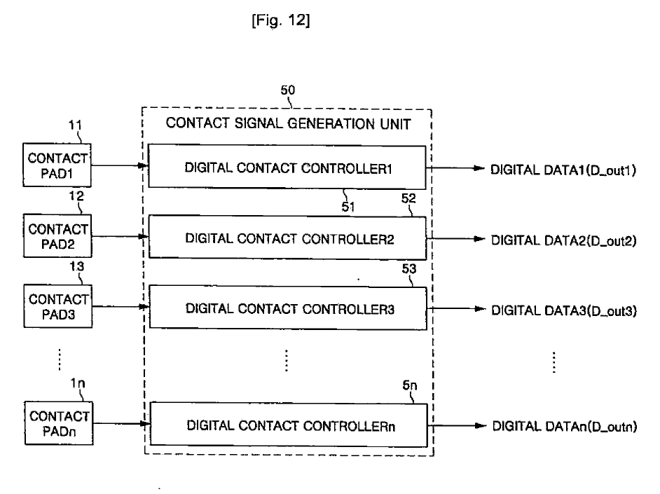

FIG. 12 illustrates a contact signal generation unit employed together with a touchpad of the present invention. The contact signal generation unit 50 comprises a plurality of digital contact controllers 51 to 5n, which respectively correspond to a plurality of contact pads 11 to 1n in the touchpad. When a contact pad is touched from outside, its impedance varies. The corresponding digital contact controller senses delay according to the change in impedance and outputs digital data D_out1 to D_outn.

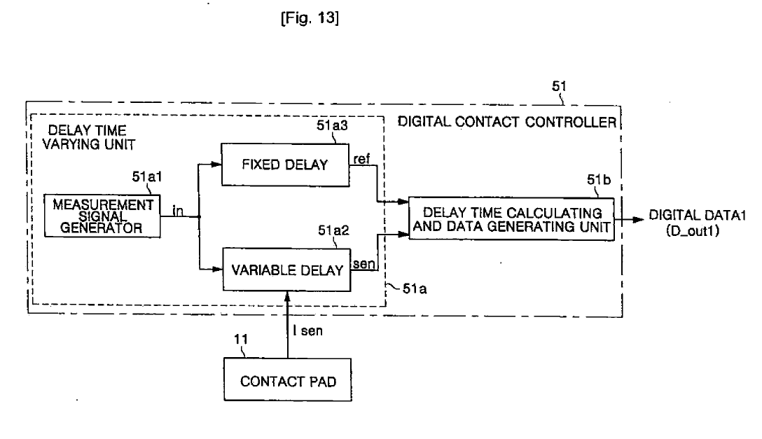

FIG. 13 is a block diagram of a digital contact controller included in the contact signal generation unit. The digital contact controller comprises a delay time varying unit 51a and a delay time calculating and data generating unit 51b. The delay time varying unit 51a comprises a measurement signal generator 51a1, a variable delay 51a2, and a fixed delay 51a3.

A contact pad1 11 changes an impedance value Isen according to the intensity of an external stimulus. Any kind of device whose capacitance, inductance, or resistance value is changed according to the intensity of an external stimulus may be used as the contact pad.

The delay time varying unit 51a generates a reference signal ref and a sensing signal sen having a difference in delay time that changes in proportion to the impedance value Isen of the contact pad1 11. The measurement signal generator 51a1 generates a measurement signal in at intervals of a first duration and applies it to the variable delay 51a2 and the fixed delay 51a3. The variable delay 51a2 connected with the contact pad1 11 delays the measurement signal in according to the impedance value of the variable delay 51a2 itself and the impedance value Isen of the contact pad1 11 and generates the sensing signal sen. And, the fixed delay 51a3 delays the measurement signal in according to the impedance value of the fixed delay 51a3 itself and generates the reference signal ref

The delay time calculating and data generating unit 51b receives the reference signal ref and the sensing signal sen, calculates the difference in delay time between the reference signal ref and the sensing signal sen, and generates digital data1 D_out1 of a value corresponding to the calculated difference in delay time.

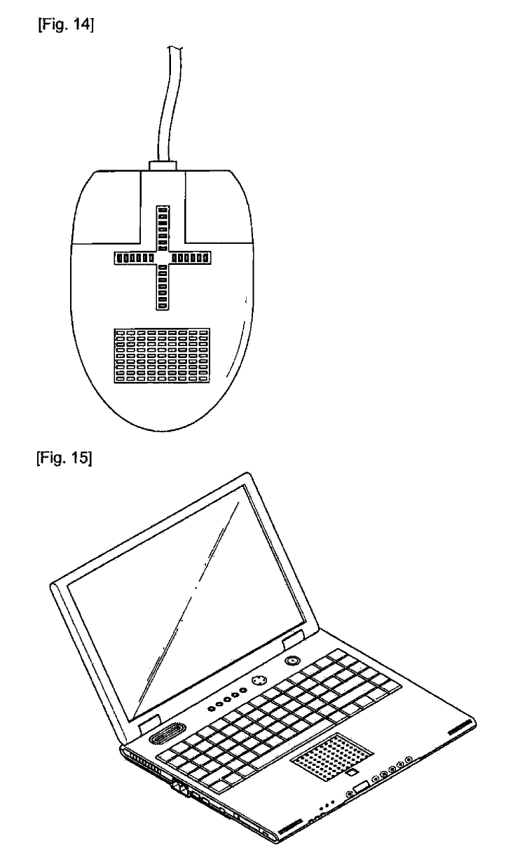

FIGS. 14 and 15 illustrate examples of application of the present invention. FIG. 6 illustrates a mouse having a scroll unit and a cursor movement unit employing the structures according to the first and third exemplary embodiments. In the cross scroll unit disposed above the center of the mouse, a plurality of pads for tactile sensation are disposed in a predetermined pattern to scroll a screen in 4 directions, i.e., up, down, right and left. Folded rectangles denote protruding portions to enable a user's sense of touch. The cursor movement unit disposed under the center of the mouse employs a touchpad having a structure according to the third exemplary embodiment to move a cursor on the screen. Rectangles denote protruding portions to enable a user to feel the touchpad better when the user's finger comes in contact with the portion.

Thus far, it has been assumed that a person's finger touches a touchpad of the present invention. However, even when a pen emitting electromagnetic waves is used, it is possible to enable a user to feel the touchpad better by changing the contact signal generation unit of the present invention with an electromagnetic-wave generator.

FIG. 15 illustrates a notebook employing a touchpad having a structure according to the second exemplary embodiment. A plurality of circles formed all over the touchpad in the same pattern denote protruding portions to enable a user to feel the touchpad better.

While the invention has been shown and described with reference to certain exemplary embodiments thereof, it will be understood by those skilled in the art that various changes in form and details may be made therein without departing from the spirit and scope of the invention as defined by the appended claims.

1. A touchpad comprising:
a printed circuit board (PCB);
a plurality of conductors; and
a non-conductive board disposed on one surface of the PCB and having a plurality of protrusions, each of the plurality of protrusions including each of the plurality of conductors therein.

2. A touch sensor comprising:
a touchpad comprising a printed circuit board (PCB), a plurality of conductors, and a non-conductive board disposed on one surface of the PCB and having a plurality of protrusions, each of the plurality of protrusions including each of the plurality of conductors therein; and
a contact signal generation unit comprising a plurality of digital contact controllers for sensing delay due to a change in impedance between each of the plurality of conductors in each of the plurality of protrusions and the PCB to output a digital signal.

3. The touch sensor according to claim 2, wherein the changed impedance is one of an electrostatic capacitance, and an inductive capacitance and a resistance.

4. The touch sensor according to claim 2, wherein each of the digital controllers comprises:
a delay time varying unit for generating a reference signal having a fixed delay time and a sensing signal having a delay time that varies according to an impedance of a signal applied from outside; and
a delay time calculating and data generating unit for calculating a difference in delay time between the reference signal and the sensing signal, and generating digital data having a value corresponding to the calculated difference in delay time.

5. The touch sensor according to claim 4, wherein the delay time varying unit comprises:
a measurement signal generator for generating a measurement signal;
a fixed delay for delaying the measurement signal for a predetermined time period and generating the reference signal; and
a variable delay for changing a delay time according to the impedance of the signal applied from outside, delaying the measurement signal according to the varied delay time, and generating the sensing signal.

6. A touchpad comprising:
a printed circuit board (PCB);
a plurality of PCB electrodes disposed on one surface of the PCB;
a non-conductive flat board disposed on the PCB electrodes and covering one entire surface of the PCB except portions at which the PCB electrodes are disposed; and
a plurality of conductive buttons put into the uncovered portions of the non-conductive flat board and having respective upper parts protruding above a surface of the non-conductive flat board.

7. A touch sensor comprising a touchpad and a contact signal generation unit, wherein the touchpad comprises:
a printed circuit board (PCB);
a plurality of PCB electrodes disposed on one surface of the PCB;
a non-conductive flat board disposed on the PCB electrodes and covering one entire surface of the PCB except portions at which the PCB electrodes are disposed; and
a plurality of conductive buttons put into the uncovered portions of the non-conductive flat board and having respective upper parts protruding above a surface of the non-conductive flat board, and
the contact signal generation unit comprises a plurality of digital contact controllers for sensing delay due to a change in impedance between the conductive buttons and the PCB electrodes caused by external contact to output a digital signal.

8. The touch sensor according to claim 7, wherein the changed impedance is one of an electrostatic capacitance, an inductive capacitance and a resistance.

9. The touch sensor according to claim 8, wherein each of the digital controllers comprises:
a delay time varying unit for generating a reference signal having a fixed delay time and a sensing signal having a delay time that varies according to an impedance of a signal applied from outside; and
a delay time calculating and data generating unit for calculating a difference in delay time between the reference signal and the sensing signal, and generating digital data having a value corresponding to the calculated difference in delay time.

10. The touch sensor according to claim 9, wherein the delay time varying unit comprises:
a measurement signal generator for generating a measurement signal;
a fixed delay for delaying the measurement signal for a predetermined time period to generate the reference signal; and
a variable delay for varying a delay time according to the impedance of the signal applied from outside, delaying the measurement signal according to the varied delay time to generate the sensing signal.

11. A touchpad comprising:
a printed circuit board (PCB);
a plurality of PCB electrodes disposed on one surface of the PCB; and
a non-conductive board disposed on the PCB electrodes and having a plurality of depressed portions and embossed portions corresponding to the PCB electrodes.

12. A touch sensor comprising a touchpad and a contact signal generation unit, wherein the touchpad comprises:
a printed circuit board (PCB);
a plurality of PCB electrodes disposed on one surface of the PCB; and
a non-conductive board disposed on the PCB electrodes and having a plurality of depressed portions and embossed portions corresponding to the PCB electrodes, and
the contact signal generation unit comprises a plurality of digital contact controllers for sensing delay due to a change in impedance between bottoms of the depressed portions and the PCB electrodes caused by external contact and outputting a digital signal.

13. The touch sensor according to claim 12, wherein the changed impedance is one of an electrostatic capacitance, an inductive capacitance and a resistance.

14. The touch sensor according to claim 13, wherein each of the digital controllers comprises:
a delay time varying unit for generating a reference signal having a fixed delay time and a sensing signal having a delay time that varies according to an impedance of a signal applied from outside; and
a delay time calculating and data generating unit for calculating a difference in delay time between the reference signal and the sensing signal, and generating digital data having a value corresponding to the calculated difference in delay time.

15. The touch sensor according to claim 14, wherein the delay time varying unit comprises:
a measurement signal generator for generating a measurement signal;
a fixed delay for delaying the measurement signal for a predetermined time period and generating the reference signal; and
a variable delay for changing a delay time according to the impedance of the signal applied from outside, delaying the measurement signal according to the varied delay time, and generating the sensing signal.
